(19) United States
(12) Patent Application Publication
(10) Pub. No.: US 2004/0059879 A1
(43) Pub. Date: Mar. 25, 2004

(54) Access priority protocol for computer system

(76) Inventor: Paul L. Rogers, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/261,460

(22) Filed: Sep. 23, 2002

(51) Int. Cl. G06F 12/00

(52) U.S. Cl. 711/154

(57) ABSTRACT

A computer system has multiple agents sharing a resource. When a request for access to the shared resource is denied, a counter is initialized. Each subsequent transaction for the shared resource is counted. When the counter reaches a threshold, the priority of the access request is increased. The threshold may be programmable. Requests may be sorted into queues, with each queue having a separately programmable threshold. Multiple requests from one queue may then be granted without interruption. In an example embodiment, a cache memory has multiple queues, and each queue has an associated counter with a programmable threshold.

### FIELD OF INVENTION

This invention relates generally to computer systems.

### BACKGROUND OF THE INVENTION

It is common in computer systems to have multiple devices or software processes sharing a resource, such as a bus, an input-output port, a memory, or a peripheral device. There are many methods for control of access, or arbitration for access, to a shared resource. For example, access may be granted in the temporal order of request (first-in-first-out), or a “round robin” scheme may be used to sequentially poll each potential user. Alternatively, some devices or processes may be assigned relative priorities, so that requests are granted out-of-order. If priorities are fixed, it is possible that a low priority device or process is forced to “starve” or stall. There are methods to change priorities to ensure that every device or process eventually gets access. For example, a least-recently-used algorithm may be used in which an arbiter grants the request that has least recently been granted. Some requests may be inherently more urgent than others, and some requests may require a guaranteed minimum response time. There is an ongoing need for improved algorithms for granting access to a shared resource.

### SUMMARY OF THE INVENTION

When a request for access to a shared resource is denied, a counter is initialized. Each subsequent transaction for the shared resource is counted. When the counter reaches a threshold, the priority of the access request is increased. The threshold may be programmable. Requests may be sorted into queues, with each queue having a separately programmable threshold. Multiple requests from one queue may then be granted without interruption. In an example embodiment, a cache memory has multiple queues, and each queue has an associated counter with a programmable threshold.

### BRIEF DESCRIPTION OF THE DRAWINGS

FIG. 1 is a block diagram of an example computer system.

FIG. 2 is a flow chart of an example method for use with the system of FIG. 1.

FIG. 3 is a block diagram of an example computer system with a cache memory.

FIG. 4 is a state diagram for the example system of FIG. 3.

### DETAILED DESCRIPTION

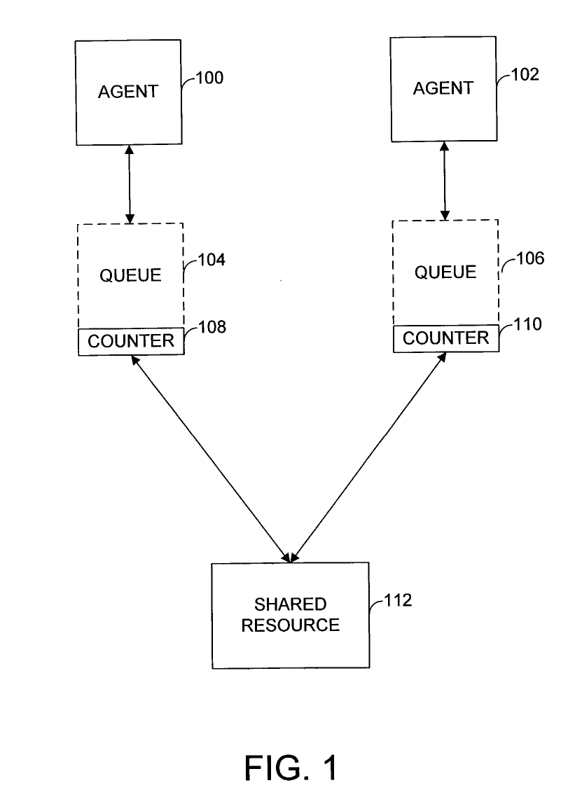

FIG. 1 illustrates a system in which two agents (100, 102) share a resource 112. An agent is anything that can request access to the resource 112, including for example, computer processors, memory controllers, bus controllers, peripheral devices, and software processes. The shared resource may be, for example, a memory, a bus, an input/output port, or a peripheral device. In general, a shared resource may not be able to respond to all requests for access in real time, so queues (104, 106) may optionally be used to store pending access requests. Each request for access (at the output of a queue, if there are queues) has an associated priority. When there are multiple simultaneous requests for access, the request with the highest priority is granted access. In case of equal priority, various algorithms may be used to determine which request is granted, for example, round-robin, or least recently used. The system includes at least one counter, depicted in the example of FIG. 1 as counters 108 and 110 associated with the queues 104 and 106. The counters may be located in the queues or elsewhere, and may be implemented in software, in a processor, or as fields within a register, where the fields can be individually incremented or decremented and initialized.

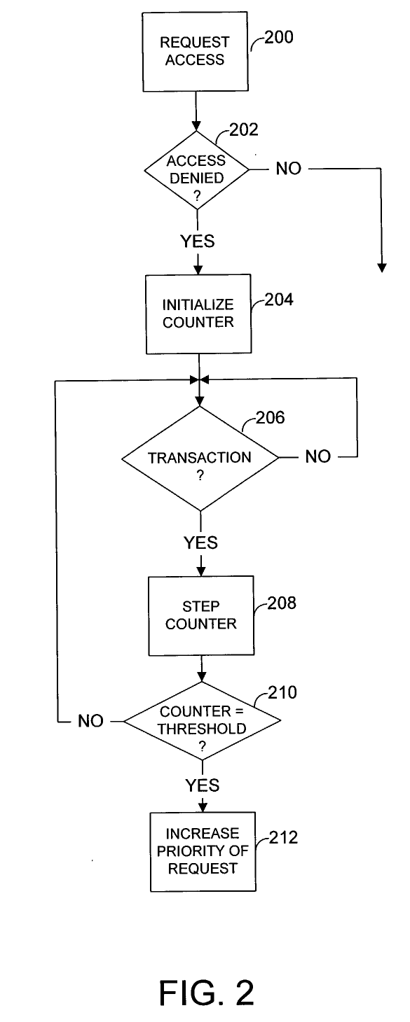

FIG. 2 illustrates an example method for use with the system of FIG. 1. At reference 200, there is a request for access to the shared resource. If there is a queue, then the request for access represented by reference 200 is at the output of the queue. That is, the request is one that is being presented to the shared resource, not a request that is pending in the queue. At reference 202, if the request is denied, then a counter is initialized. The term initialized includes “reset” or “preset”; that is, the counter may start at zero and count up or down to a threshold, or may start at some other number and count up or down to a threshold. The counter threshold may optionally be programmable. For each subsequent transaction (reference 206), the counter is stepped (incremented, or decremented, depending on the implementation, and the step is not limited to one) (reference 208). When the counter reaches a predetermined threshold (reference 210), the priority is increased for the pending request for access from reference 200. For example, in the system of FIG. 1, assume that requests from agent 102 initially have a higher priority than requests from agent 100, and assume that for agent 100 the threshold count is four. If a request for access by agent 100 is denied because of pending requests from agent 102, the system will permit up to four transactions by the shared resource (for example, four accesses by agent 102) before increasing the priority of the request from agent 100.

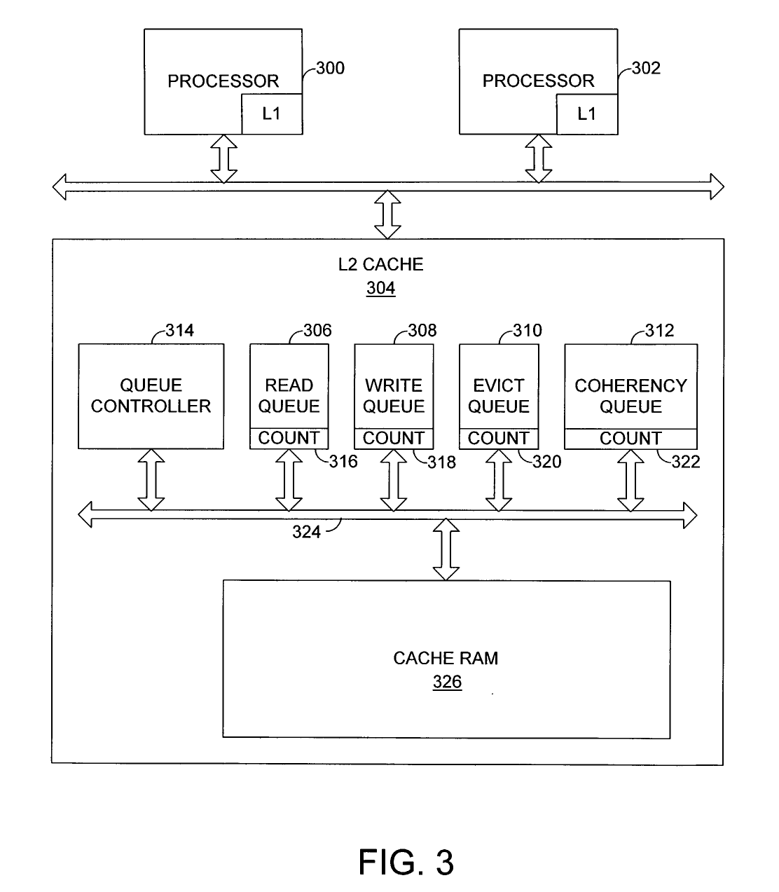

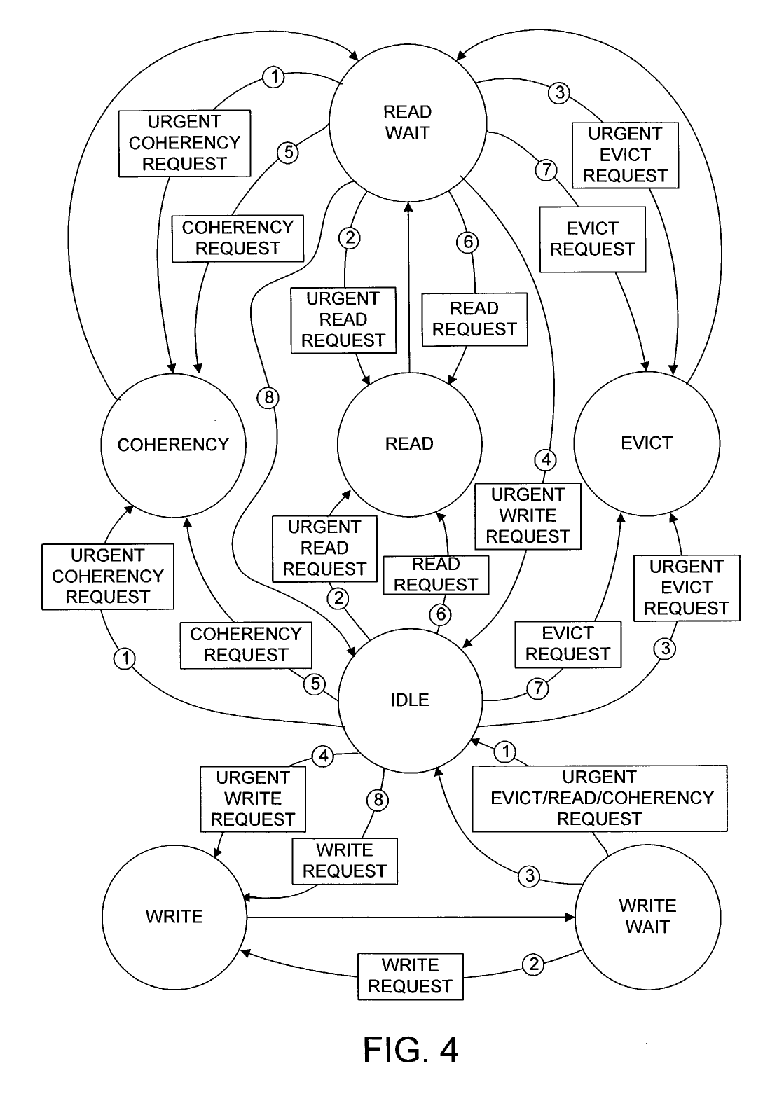

FIGS. 3 and 4 illustrate a specific example system in which multiple processors share a cache. In FIG. 3, two processors 300 and 302, with integrated first level (L1) cache memories, share a second level (L2) cache memory 304. There may be more than two processors, and there may be more than two levels of cache. FIG. 3 may depict a node within a larger system, and there may be multiple nodes, each with multiple processors, and each with an L2 cache. All processors and caches may share a common main memory (not illustrated). Within the L2 cache (304), there are request queues (306, 308, 310, and 312) for access to the cache random access memory (RAM) 326. A read queue 306 holds requests to read from the cache RAM 326, to provide data to the processors 300 and 302, in case of a L1 cache miss and a L2 cache hit. A write queue 308 holds requests, from one of the processors (300, 302) or from a system bus (not illustrated), to write to the cache RAM 326. If new data must be written to the cache RAM, and there is no empty space, then an existing entry in the cache RAM must be evicted. An evict queue 310 holds data that is being evicted from the cache RAM 326, which will later be written to main system RAM (not illustrated). Copies of a particular data item may simultaneously exist in main memory and in the cache hierarchies for multiple processors. If the copy of a data item in a cache is different than the copy in main memory, then the data item in the cache is said to be “dirty”. In FIG. 3, a coherency queue 312 holds requests, from remote agents (for example, other nodes), for data items in the cache RAM 326 that are dirty. A queue controller 314 determines which request from which queue is granted access to the cache RAM 326. Each queue has an associated counter (316, 318, 320, 322) (or register, or field in a register), which will be discussed in more detail below.

FIG. 4 illustrates a state diagram implemented by the queue controller of FIG. 3. There are seven states, Idle, Read, Read-Wait, Write, Write-Wait, Coherency, and Evict. Small circles with numbers indicate priority, with “1” being highest priority, and “8” being lowest priority. For example, in the Idle state, an urgent coherency request has the highest priority. For reading or writing to the cache RAM 326, an address is transferred, and then additional time is required to complete the data transfer. Data is being read during the Read-Wait state, and data is being written during the Write-Wait state. For each of the four states depicted above the Idle state in FIG. 4, the bus 324 to the cache RAM 326 is switched to a direction for reading from the cache RAM. In the Coherency, Read, and Evict states, an address is transferred and some data is read, and the remaining part of the data corresponding to the address is read during the Read-Wait state. For each of the two states below the Idle state in FIG. 4, the bus 324 to the cache RAM 326 is switched to a direction for Writing. An address is transferred, and some data is written, during the Write state, and the remaining part of the data corresponding to the address is written during the Write-Wait state.

It takes a few clock cycles to switch a memory bus from read to write, and from write to read, so grouping transactions together that involve reading from memory (for example, reads from a cache memory to a processor, coherency transactions, and eviction transactions), and grouping writes to memory together, can improve performance by reducing the number of times a bus has to be switched from read to write. A write from a processor to memory can usually be delayed without affecting performance, but any delay in execution of a read from memory to a processor, or any delay in execution of a coherency transaction, may decrease performance. In the following discussion, an access priority protocol, as discussed in conjunction with FIGS. 1 and 2, is implemented in the example system of FIGS. 3 and 4 to improve performance. In particular, transactions involving reading from memory are grouped together, and writes to memory are grouped together, and transactions involving reading from memory are given priority over writes to memory.

In FIG. 3, when each queue (306, 308, 310, and 312) first provides a request to access the cache RAM, the request has a normal priority. Note in FIG. 4 that normal coherency requests have a priority of 5, normal read requests have a priority of 6, normal eviction requests have a priority of 7. Normal write requests (at the Idle state) have a priority of 8 (the priority of normal write requests is state dependent). In FIG. 3, each queue has a counter (316, 318, 320, 322), accessible by firmware, that is used to control how many cache RAM transactions can occur before the access request from the queue is changed to an urgent priority. Note in FIG. 4 that urgent coherency requests have a priority of 1, urgent read requests have a priority of 2, urgent eviction requests have a priority of 3, and urgent write requests have a priority of 4.

Consider a specific example with assumed maximum count thresholds. Assume that the Read queue and the Coherency queue each have two-bit counters (or two-bit fields within a register), and the Write queue and Evict Queue each have five-bit counters (or five-bit fields within a register). As a result, the Read and Coherency queues can allow zero to three cache RAM transactions to be completed before asserting an urgent request. The Write and Evict queues can allow zero to 31 cache RAM transactions to be completed before asserting an urgent request. For example, a group of 31 read requests may be granted before a write request is granted, and once the write request is granted, then three write requests may be granted before another group of read requests are granted. This grouping of reads and writes improves performance by reducing the number of times the memory bus 324 has to switched from read to write or from write to read.

In FIG. 4, note for example, at the Read-Wait state, a normal write request will never interrupt a series of reads, but an urgent write request (priority 4) will have priority over a normal read request (priority 6). Note also that changing a priority to urgent does not guarantee access. For example, at the Read-Wait state, an urgent coherency request (priority 1), an urgent read request (priority (2), and an urgent evict request (priority 3), all have a higher priority than an urgent write request (priority 4). Accordingly, the priority system facilitates groups of transactions that involve reading from memory, and facilitates groups of writes to memory, but still provides for interruption by high priority access requests.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A computer system, comprising:
a shared resource; and
a counter, the counter determining a maximum number of transactions that can occur for the shared resource before a priority for a particular access request is made higher.

2. The computer system of claim 1 where the maximum number of transactions is programmable.

3. The computer system of claim 1 where the shared resource is a cache.

4. The computer system of claim 1, further comprising:
a plurality of queues, each queue capable of holding a plurality of requests for access to the shared resource; and
each queue having an associated counter, where for each queue, the associated counter determines a maximum number of transactions that can occur for the shared resource before a priority for an access request, at the output of the queue, is made higher.

5. A method, comprising:
requesting, by an agent, access to a resource that is shared, the request having a priority;
counting transactions by the resource; and
increasing the priority of the request by the agent, when transactions by the resource equal a predetermined threshold.

6. The method of claim 5, further comprising:
storing pending requests for access by the agent in a queue.

7. A computer system, comprising:
a shared resource;
means for counting transactions by the shared resource, when a request for access to the shared resource is denied; and
means for changing a priority of the request when the transactions by the shared resource reach a predetermined number.

8. A computer system, comprising:
a cache;
a plurality of queues, each queue capable of holding a plurality of requests for access to the cache; and
each queue having an associated counter, where for each queue, the associated counter determines a maximum number of transactions that can occur for the cache before a priority for an access request, at the output of the queue, is made urgent.

9. The computer system of claim 8, further comprising:
a normal priority for read transactions is higher than a normal priority for write transactions, thereby assisting read transactions to be grouped together.
